(19) United States
(12) Patent Application Publication
(10) Pub. No.: US 2025/0219206 A1
(43) Pub. Date: Jul. 3, 2025

(54) POWER STORAGE MODULE AND MANUFACTURING METHOD OF POWER STORAGE MODULE

(71) Applicant: TOYOTA JIDOSHA KABUSHIKI KAISHA, Toyota-shi (JP)

(72) Inventor: Satoshi NAKASHIMA, Toyota-shi (JP)

(73) Assignee: TOYOTA JIDOSHA KABUSHIKI KAISHA, Toyota-shi (JP)

(21) Appl. No.: 18/906,367

(22) Filed: Oct. 4, 2024

(30) Foreign Application Priority Data
Dec. 28, 2023 (JP) 2023-223035

(51) Int. Cl. H01M 50/141; H01M 4/02; H01M 4/13; H01M 10/0525; H01M 10/0585; H01M 50/105; H01M 50/119; H01M 50/126

(52) U.S. Cl. CPC H01M 50/141; H01M 4/13; H01M 10/0525; H01M 10/0585; H01M 50/105; H01M 50/119; H01M 50/126; H01M 2004/027; H01M 2004/028; H01M 2004/029

(57) ABSTRACT

A power storage module includes a laminate including a plurality of stacked electrodes and a pair of sheet members joined to each other, and an outer encasement for sealing the laminate inside, the plurality of electrodes including a cathode terminal electrode including a cathode active material layer, an anode terminal electrode including an anode active material layer, and a bipolar electrode disposed between the cathode terminal electrode and the anode terminal electrode, wherein each of the pair of sheet members has a peeling portion in which a portion of each of the pair of insulating layers is peeled from a metal layer disposed between the pair of insulating layers, and one of the pair of sheet members is disposed so as to face the anode terminal electrode, and the other peeling portion of the pair of sheet members is disposed so as to face the cathode terminal electrode.

### CROSS-REFERENCE TO RELATED APPLICATION

This application claims priority to Japanese Patent Application No. 2023-223035 filed on Dec. 28, 2023, incorporated herein by reference in its entirety.

### BACKGROUND

### 1. Technical Field

The present disclosure relates to a power storage module and a manufacturing method of the power storage module.

### 2. Description of Related Art

In a non-aqueous secondary battery in which an electrolyte is made up of a non-aqueous electrolyte, it is known that battery performance deteriorates due to intrusion of moisture into the inside of the battery. Specifically, when moisture intrudes into the inside of the battery, the electrolyte may be altered such that resistance increases, or active materials or coatings may be decomposed due to the altered component, and the battery performance may deteriorate. Accordingly, in non-aqueous secondary batteries, it is important to ensure airtightness of an outer encasement of the battery, in order to suppress intrusion of moisture, such as moisture in the atmosphere and so forth. As an example of a non-aqueous secondary battery, Japanese Unexamined Patent Application Publication No. 2023-110291 (JP 2023-110291 A) discloses a power storage module having a laminate including a bipolar electrode, and cathode and anode terminal electrodes.

The power storage module described in JP 2023-110291 A includes the laminate having an outer side face, and a sheet member provided in close contact with the laminate so as to cover the outer side face in a cross section along a lamination direction of the laminate. The laminate includes a current collector having one face and another face in the lamination direction, and at least one of a cathode active material layer and an anode active material layer. A plurality of the current collectors has a plurality of electrodes laminated so that the one face is oriented in the same direction along the lamination direction, and a sealing portion defining a space for accommodating an electrolyte along with the current collectors that are adjacent to each other in the lamination direction. The electrodes each includes a bipolar electrode, a cathode terminal electrode, and an anode terminal electrode. The bipolar electrode has the cathode active material layer provided on the one face of the current collector, and the anode active material layer provided on the other face of the current collector. The cathode terminal electrode has the cathode active material layer provided on the one face of the current collector, and has an exposed portion exposed from the sealing portion on the other face of the current collector. The anode terminal electrode has the anode active material layer provided on the other face of the current collector, and has an exposed portion exposed from the sealing portion on the one face of the current collector. The sealing portion has a plurality of first resin layers, a plurality of spacers, and a second resin layer. The first resin layers have a frame shape provided at respective peripheral edge portions of the current collectors. The spacers have a frame shape arranged so as to be interposed between the first resin layers adjacent to each other in the lamination direction. The second resin layer is formed by fusing, to each other, end portions of the first resin layers and the spacers on the opposite side to the respective spaces as viewed from the lamination direction. The outer side face includes a first surface, a second surface, and a third surface. The first surface is a surface on an opposite side from the other face of the current collector of the first resin layer that is provided on the other face of the current collector of the cathode terminal electrode. The second surface is a surface on an opposite side from the one face of the current collector of the first resin layer that is provided on the one face of the current collector of the anode terminal electrode. The third surface is a surface on an opposite side from the space in the second resin layer, and extends connecting the first surface and the second surface. The sheet member includes a metal layer and a first insulating layer that is laminated on the metal layer and disposed on an outer side face side from the metal layer. The sheet member extends from the first surface over the third surface, and reaches the second surface. A first end portion on the first surface of the sheet member and a second end portion on the second surface of the sheet member are situated on an outer side from an inner edge of the first resin layer and the spacer and on an inner side of an outer edge of the current collector as viewed from the lamination direction. A first insulating member is provided over the sheet member from the first surface so as to cover the first end portion, and is bonded to the first surface and the sheet member. A second insulating member is provided over the sheet member from the second surface so as to cover the second end portion, and is bonded to the second surface and the sheet member.

It is described in JP 2023-110291 A that moisture intrusion into the laminate is suppressed in this power storage module due to the sheet member including the metal layer being provided so as to cover the outer side face of the laminate, as compared with when providing a sheet of resin layer alone.

### SUMMARY

Now, in a power storage device including a power storage module, a plurality of power storage modules may be stacked via conductive members. In this case, the power storage modules adjacent to each other are electrically connected to each other via the conductive members.

Accordingly, when an entire surface of a laminate is sealed by a sheet member including a resin layer, for example, conduction between the laminate and the conductive member cannot be secured. In order to ensure conduction between the laminate and the conductive member, it is conceivable to expose at least a part of cathode and anode terminal electrodes included in the laminate, sealed by the sheet member, to outside of the sheet member, as in the technology described in JP 2023-110291 A. However, in such a configuration, moisture easily enters from between an end portion of the sheet member situated at the exposed portions of the cathode and anode terminal electrodes, and the cathode and anode terminal electrodes. Accordingly, while short-circuiting can be suppressed in the power storage module described in JP 2023-110291 A by using a sheet member including a metal layer, there is a problem in that intrusion of moisture cannot be sufficiently suppressed.

The present disclosure has been made to solve such a problem, and an object thereof is to provide a power storage module and a manufacturing method of the power storage module, capable of suitably suppressing intrusion of moisture while suppressing short-circuiting.

A power storage module according to an embodiment includes a laminate including a plurality of electrodes laminated along a laminating direction, and an outer encasement that is made up of a pair of sheet members joined to each other so as to envelop the laminate, and that seals the laminate inside.
The electrodes
each contain a current collector having one face and another face opposed to each other in the laminating direction, with the one face oriented in a same direction along the laminating direction, and the electrodes include
a cathode terminal electrode including a cathode active material layer provided on the one face of the current collector,
an anode terminal electrode including an anode active material layer provided on the other face of the current collector so as to oppose the cathode active material layer, and
at least one bipolar electrode disposed between the cathode terminal electrode and the anode terminal electrode.
Each of the sheet members includes
a pair of insulating layers,
a metal layer disposed between the insulating layers, and
a peeling portion in which a portion of each of the insulating layers is peeled away from the metal layer.
The peeling portion of one of the sheet members is disposed opposing the anode terminal electrode, and the peeling portion of the other of the sheet members is disposed opposing the cathode terminal electrode.

Further, a manufacturing method of a power storage module according to an embodiment includes
fabricating a laminate including a plurality of electrodes laminated along a laminating direction, and
sealing the laminate inside an outer encasement that is made up of a pair of sheet members joined to each other so as to envelop the laminate.
The electrodes
each contain a current collector having one face and another face opposed to each other in the laminating direction, with the one face oriented in a same direction along the laminating direction, and the electrodes include
a cathode terminal electrode including a cathode active material layer provided on the one face of the current collector,
an anode terminal electrode including an anode active material layer provided on the other face of the current collector so as to oppose the cathode active material layer, and
at least one bipolar electrode disposed between the cathode terminal electrode and the anode terminal electrode.
Each of the sheet members includes
a pair of insulating layers,
a metal layer disposed between the insulating layers, and
a peeling portion in which a portion of each of the insulating layers is peeled away from the metal layer.
The peeling portion of one of the sheet members is disposed opposing the anode terminal electrode, and the peeling portion of the other of the sheet members is disposed opposing the cathode terminal electrode.

According to the present disclosure, a power storage module and a manufacturing method of the power storage module, capable of suitably suppressing intrusion of moisture while suppressing short-circuiting, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view of a power storage module according to Embodiment 1;

FIG. 2 is a perspective view of the power storage module shown in FIG. 1;

FIG. 3 is a flow chart showing a manufacturing process of the power storage module according to the first embodiment; and

FIG. 4 is a perspective view and a partially enlarged cross-sectional view of a power storage module according to a modification.

### DETAILED DESCRIPTION OF EMBODIMENTS

### Embodiment 1

Hereinafter, embodiments of the present disclosure will be described with reference to the drawings. However, the present disclosure is not limited to the following embodiments. Further, for clarity of explanation, the following description and the drawings are simplified as appropriate. In the following description, the same or equivalent elements are denoted by the same reference numerals, and redundant description will be omitted.

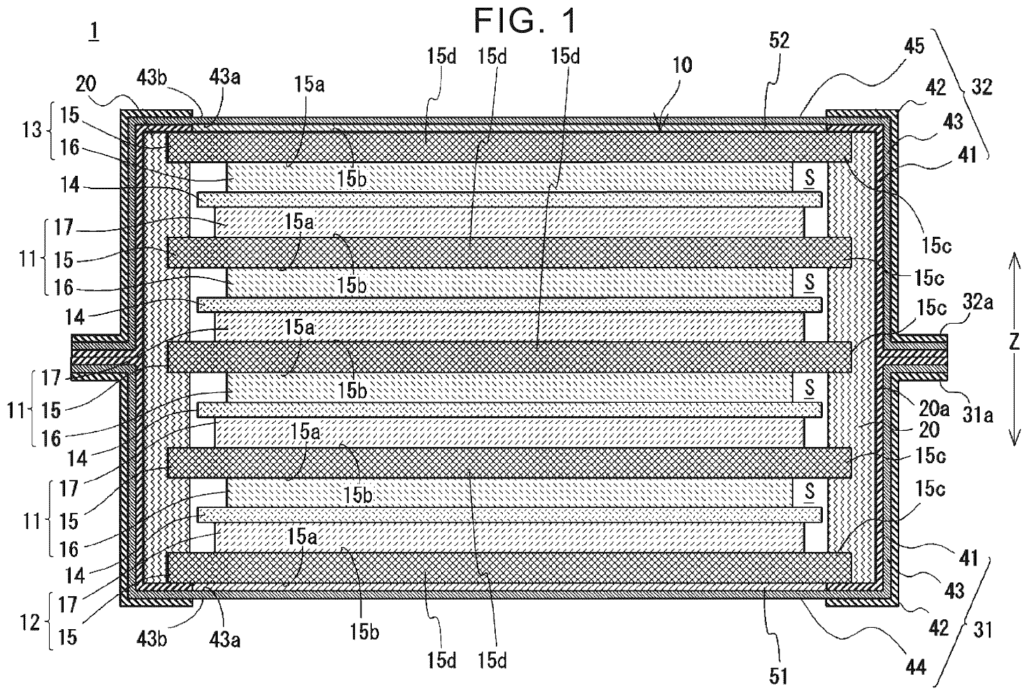

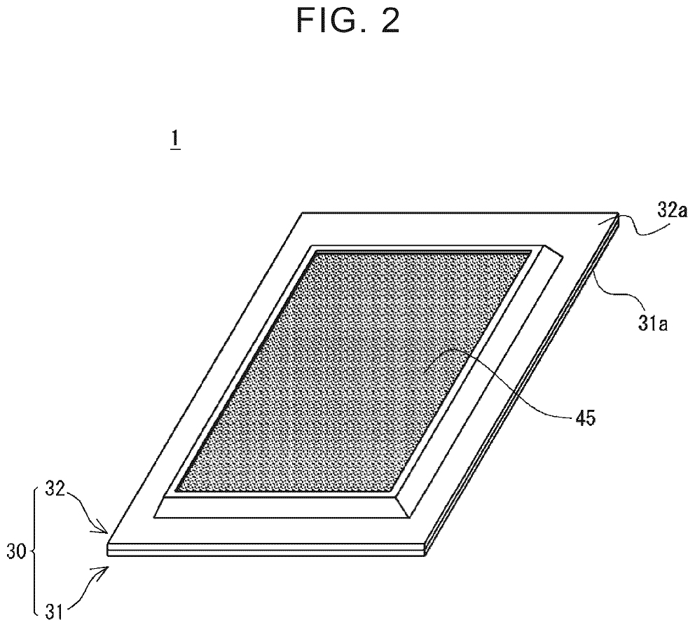

Referring to FIGS. 1 and 2, a power storage module 1 according to a first embodiment will be described. FIG. 1 is a schematic cross-sectional view of a power storage module according to a first embodiment. FIG. 2 is a perspective view of the power storage module shown in FIG. 1. The power storage module 1 illustrated in FIGS. 1 and 2 is used, for example, in batteries of various vehicles such as a forklift truck and a hybrid electric vehicle, battery electric vehicle. The power storage module 1 is, for example, a secondary battery such as a nickel-hydrogen secondary battery or a lithium-ion secondary battery. The power storage module 1 may be an electric double layer capacitor or an all-solid-state battery. In the present embodiment, a case where the power storage module 1 is a lithium ion secondary battery is exemplified.

The power storage module 1 includes a laminate 10 and an outer encasement 30. As illustrated in FIG. 1, the laminate 10 includes a plurality of electrodes stacked along a Z direction that is a stacking direction. The laminate 10 includes a plurality of separators 14, a sealing portion 20, and an electrolyte (not shown) in addition to the plurality of electrodes. The plurality of electrodes includes a plurality of bipolar electrodes 11, an anode terminal electrode 12, and a cathode terminal electrode 13.

The bipolar electrode 11 includes a current collector 15, a cathode active material layer 16, and an anode active material layer 17. The current collector 15 has, for example, a rectangular sheet shape. The cathode active material layer 16 is provided on one face 15a of the current collector 15. The anode active material layer 17 is provided on the other face 15b of the current collector 15. The plurality of bipolar electrodes 11 are stacked such that the cathode active material layer 16 of one bipolar electrode 11 and the anode active material layer 17 of another bipolar electrode 11 face each other. one face 15a of the current collector 15 is a surface facing one side in the Z direction, and the other face 15b of the current collector 15 is a surface facing the other side in the Z direction.

The cathode active material layer 16 and the anode active material layer 17 have a rectangular shape when viewed in the Z direction. The anode active material layer 17 is larger than the cathode active material layer 16 in the Z direction. That is, the entire formation region of the cathode active material layer 16 is located in the formation region of the anode active material layer 17 in a plan view viewed from the Z direction.

The anode terminal electrode 12 includes a current collector 15 and anode active material layers 17 provided on the other face 15b of the current collector 15. In the anode terminal electrode 12, the cathode active material layer 16 and the anode active material layer 17 are not provided on one face 15a of the current collector 15. That is, the active material layers are not provided on one face 15a of the current collector 15 included in the anode terminal electrode 12. The anode terminal electrode 12 is disposed at one end of the laminate 10 in the Z direction such that the other face 15b faces the inside in the Z direction. The anode terminal electrode 12 is laminated on the bipolar electrode 11 such that the anode active material layer 17 faces the cathode active material layer 16 of the bipolar electrode 11. Therefore, one face 15a of the current collector 15 included in the anode terminal electrode 12 faces the outer side of the laminate 10, and is an exposed surface at least partially exposed to the outside of the laminate 10. In the present embodiment, one face 15a of the current collector 15 included in the anode terminal electrode 12 is an exposed surface that is entirely exposed to the outside of the laminate 10.

The cathode terminal electrode 13 includes a current collector 15 and a cathode active material layer 16 provided on one face 15a of the current collector 15. In the cathode terminal electrode 13, the cathode active material layer 16 and the anode active material layer 17 are not provided on the other face 15b of the current collector 15. That is, the active material layers are not provided on the other face 15b of the current collector 15 included in the cathode terminal electrode 13. The cathode terminal electrode 13 is disposed at the other end of the laminate 10 in the Z direction such that one face 15a faces the inside in the Z direction. The cathode terminal electrode 13 is laminated on the bipolar electrode 11 such that the cathode active material layer 16 faces the anode active material layer 17 of the bipolar electrode 11. Therefore, the other face 15b of the current collector 15 included in the cathode terminal electrode 13 faces the outer side of the laminate 10, and is an exposed surface at least partially exposed to the outside of the laminate 10. In the present embodiment, the other face 15b of the current collector 15 included in the cathode terminal electrode 13 is an exposed surface that is entirely exposed to the outside of the laminate 10.

As described above, the laminate 10 includes a plurality of electrodes stacked along the Z direction that is the stacking direction. The plurality of electrodes each include a current collector 15 having one face 15a and the other face 15b facing each other in the Z direction and having one face 15a facing the same direction along the Z direction. The plurality of electrodes includes a cathode terminal electrode 13, an anode terminal electrode 12, and at least one bipolar electrode 11 disposed between the cathode terminal electrode 13 and the anode terminal electrode 12. The cathode terminal electrode 13 includes a cathode active material layer 16 provided on one face 15a of the current collector 15. The anode terminal electrode 12 includes an anode active material layer 17 provided on the other face 15b of the current collector 15 so as to face the cathode active material layer 16.

The separator 14 is disposed between adjacent electrodes. That is, the separator 14 is disposed between the adjacent bipolar electrodes 11, between the anode terminal electrode 12 and the bipolar electrode 11, and between the cathode terminal electrode 13 and the bipolar electrode 11. The separator 14 is interposed between the cathode active material layer 16 and the anode active material layer 17. The separator 14 separates the cathode active material layer 16 from the anode active material layer 17, thereby allowing charge carriers such as lithium ions to pass therethrough while preventing a short circuit caused by contact between adjacent electrodes.

The current collector 15 is a chemically inert electrical conductor for continuing to flow current through the cathode active material layer 16 and the anode active material layer 17 during discharge or charging of the lithium ion secondary battery. The material of the current collector 15 is, for example, a metal material, a conductive resin material, a conductive inorganic material, or the like. Examples of the conductive resin material include a resin in which a conductive filler is added to a conductive polymer material or a non-conductive polymer material as necessary. The current collector 15 may include a plurality of layers. In this case, each layer of the current collector 15 may include the metal material or the conductive resin material described above.

A coating layer may be formed on the surface of the current collector 15. The coating layer may be formed by a known method such as plating or spray coating. The current collector 15 may have, for example, a plate shape, a foil shape (for example, metal foil), a film shape, a mesh shape, or the like. Examples of the metal foil include aluminum foil, copper foil, nickel foil, titanium foil, and stainless steel foil. Examples of the stainless-steel foil include SUS304, SUS316 or SUS301 defined by JISG4305:2015. By using a stainless steel foil as the current collector 15, the mechanical strength of the current collector 15 can be ensured. The current collector 15 may be an alloy foil or a clad foil of the above metal. When the current collector 15 has a foil shape, the thickness of the current collector 15 may be, for example, 1 μm to 100 μm.

The cathode active material layer 16 includes a cathode active material capable of occluding and releasing charge carriers such as lithium ions. Examples of the cathode active material include a lithium composite metal oxide having a layered rock salt structure, a metal oxide having a spinel structure, and a polyanionic compound. The cathode active material may be any material that can be used in a lithium ion secondary battery. The cathode active material layer 16 may include a plurality of cathode active materials. In the present embodiment, the cathode active material layer 16 contains olivine-type lithium iron phosphate (LiFePO₄) as a complex oxide.

The anode active material layer 17 includes an anode active material capable of occluding and releasing charge carriers such as lithium ions. The anode active material may be a single substance, an alloy, or a compound. Examples of the anode active material include Li, carbon, and a metallic compound. The anode active material may be an element that can be alloyed with lithium, a compound thereof, or the like. Examples of the carbon include natural graphite, artificial graphite, hard carbon (non-graphitizable carbon), and soft carbon (graphitizable carbon). Examples of artificial graphite include highly oriented graphite and mesocarbon microbeads. Examples of the element that can be alloyed with lithium include silicon and tin. In the present embodiment, the anode active material layer 17 contains graphite as a carbon-based material.

Each of the cathode active material layer 16 and the anode active material layer 17 may further include, if necessary, a conductive auxiliary agent for increasing electrical conductivity, a binder, an electrolyte, an electrolyte support salt for increasing ionic conductivity, and the like. The conductive auxiliary agent is added to increase the conductivity of each of the electrodes (the bipolar electrode 11, the anode terminal electrode 12, and the cathode terminal electrode 13). Examples of the conductive auxiliary agent include acetylene black, carbon black, and graphite.

Examples of the binder include fluorine-containing resins such as polyvinylidene fluoride, polytetrafluoroethylene, and fluorine rubber, thermoplastic resins such as polypropylene and polyethylene, imide resins such as polyimide and polyamideimide, alkoxysilyl group-containing resins, acrylic resins such as acrylic acid and methacrylic acid, styrene-butadiene rubber (SBR), alginates such as carboxymethyl cellulose, sodium alginate, and ammonium alginate, water-soluble cellulose ester crosslinked products, and starch-acrylic acid graft polymers. The binders may be used alone or in a plurality. As the solvents, for example, water, N-methyl-2-pyrrolidone (NMP), or the like is used. Examples of the electrolyte include a polymer matrix, an ion conductive polymer, and an electrolytic solution. Examples of the electrolyte supporting salt include a lithium salt and the like.

The separator 14 may be, for example, a porous sheet or a nonwoven fabric containing a polymer that absorbs and retains an electrolyte. Examples of the material of the separator 14 include polypropylene, polyethylene, polyolefin, and polyester. The separator 14 may have a single-layer structure or a multi-layer structure. The multilayer structure may have, for example, an adhesive layer or a ceramic layer as a heat-resistant layer. The separator 14 may be impregnated with an electrolyte. The separator 14 may be formed of an electrolyte such as a polymer electrolyte or an inorganic electrolyte. Examples of the electrolyte impregnated in the separator 14 include a liquid electrolyte (electrolyte solution) containing a non-aqueous solvent and an electrolyte salt dissolved in a non-aqueous solvent, or a polymer gel electrolyte containing an electrolyte held in a polymer matrix.

When the separator 14 is impregnated with an electrolyte solution, known lithium salts such as LiClO₄, LiAsF₆, LiPF₆, LiBF₄, LiCF₃SO₃, LiN(FSO₂)₂, LiN(CF₃SO₂)₂ may be used as the electrolyte salt. As the non-aqueous solvent, known solvents such as cyclic carbonates, cyclic esters, chain carbonates, chain esters, and ethers may be used. Two or more of these known solvent materials may be used in combination.

The sealing portion 20 is formed in a frame shape at a peripheral portion of the laminate 10 so as to surround the laminate 10. The sealing portion 20 may be bonded to each of the one face 15a and the other face 15b of each current collector 15 at the peripheral edge portion 15c of each current collector 15. The sealing portion 20 seals each of the spaces S between the current collectors 15 adjacent to each other in the Z direction. Each space S contains an electrolyte. That is, the sealing portion 20 defines a space S for accommodating the electrolyte together with the current collectors 15 adjacent to each other in the Z direction. When the electrolyte is in a liquid state, the sealing portion 20 prevents the electrolyte from permeating to the outside.

The sealing portion 20 suppresses intrusion of moisture or the like into the space S from the outside of the laminate 10. The sealing portion 20 prevents gas generated in each electrode from leaking to the outside of the power storage module 1 due to, for example, a charge-discharge reaction or the like. The sealing portion 20 includes an insulating material. Examples of the material of the sealing portion 20 include various resin materials such as polypropylene, polyethylene, polystyrene, ABS resin, acid-modified polypropylene, acid-modified polyethylene, and acrylonitrile styrene resin.

As shown in FIGS. 1 and 2, the outer encasement 30 is formed of a first sheet member 31 and a second sheet member 32 that are joined to each other so as to wrap around the laminate 10. The outer encasement 30 is disposed so as to be in close contact with the laminate 10. The outer encasement 30 houses and seals the laminate 10 therein. Since the interior of the outer encasement 30 is sealed, intrusion of moisture or the like from the outside of the outer encasement 30 into the interior is suppressed.

Each of the first sheet member 31 and the second sheet member 32 is a sheet member having a rectangular shape when viewed in the Z direction. Each of the first sheet member 31 and the second sheet member 32 may be formed into a predetermined shape in advance so as to be a bag shape when overlapped with each other, or may be formed into a bag shape by sandwiching and joining the laminate 10 between each other.

Each of the first sheet member 31 and the second sheet member 32 includes a first insulating layer 41, a second insulating layer 42, and a metal layer 43. The first insulating layer 41 is laminated on one face 43a of the metal layer 43 on the laminate 10 side. The second insulating layer 42 is laminated on the other face 43b of the metal layer 43 which is opposed to the one face 43a on which the first insulating layer 41 is provided. That is, the metal layer 43 is disposed between the first insulating layer 41 and the second insulating layer 42. In the present embodiment, the first insulating layers 41 are contacted with the outer side face 20a of the sealing portion 20. The first insulating layers 41 are in contact with one face 15a of the peripheral edge portion 15c of the current collector 15 included in the anode terminal electrode 12. The first insulating layer 41 contacts the other face 15b of the peripheral edge portion 15c of the current collector 15 included in the cathode terminal electrode 13. The first insulating layer 41 and the second insulating layer 42 may have a single-layer structure or a multi-layer structure. In the case of the multilayer structure, the first insulating layer 41 and the second insulating layer 42 may have, for example, an adhesive layer or the like.

The first sheet member 31 includes a first peeling portion 44 from which the first insulating layer 41 and the second insulating layer 42 are peeled from the metal layer 43. That is, the first peeling portion 44 is a portion where the metal layer 43 of the first sheet member 31 is exposed. The first peeling portion 44 of the first sheet member 31 is disposed so as to face the anode terminal electrode 12. In the first peeling portion 44, one face 43a of the laminate 10 contacts one face 15a of the non-peripheral portion 15d of the current collector 15 included in the anode terminal electrode 12. In the first peeling portion 44, the other face 43b of the laminate 10 opposite to the one face 43a is exposed to the outside of the outer encasement 30.

The second sheet member 32 includes a second peeling portion 45 from which the first insulating layer 41 and the second insulating layer 42 are peeled from the metal layer 43. That is, the second peeling portion 45 is a portion where the metal layer 43 of the second sheet member 32 is exposed. The second peeling portion 45 of the second sheet member 32 is disposed so as to face the cathode terminal electrode 13. In the second peeling portion 45, one face 43a of the laminate 10 contacts the other face 15b of the non-peripheral portion 15d of the current collector 15 included in the cathode terminal electrode 13. In the second peeling portion 45, the other face 43b of the laminate 10 opposite to the one face 43a is exposed to the outside of the outer encasement 30.

As described above, the first peeling portion 44 is electrically connected to the anode terminal electrode 12 by being in contact with the current collector 15 included in the anode terminal electrode 12. The second peeling portion 45 is electrically connected to the cathode terminal electrode 13 by being in contact with the current collector 15 included in the cathode terminal electrode 13. The first peeling portion 44 and the second peeling portion 45 have a function of electrically connecting the plurality of power storage modules 1.

The first insulating layer 41 is made of an insulating resin. The first insulating layers 41 are made of, for example, polypropylene (PP), polyethylene (PE), polyamide (PA), nylon (NY), or the like. The material of the first insulating layer 41 may be selected from the same type of material as that of the sealing portion 20 from the viewpoint of adhesion to the sealing portion 20. The second insulating layer 42 is made of, for example, an insulating resin. The second insulating layers 42 are made of, for example, polypropylene (PP), polyethylene terephthalate (PET), nylon (NY), or the like. The metal layer 43 is made of a conductive metal. The material of the metal layers 43 is aluminum (Al), an aluminum alloy, stainless steel, copper (Cu), a copper alloy, iron (Fe), or the like. As the material of the metal layer 43, a material having low moisture permeability (low moisture permeability coefficient) such as aluminum or stainless steel may be selected.

Each of the first sheet member 31 and the second sheet member 32 is, for example, a laminate sheet such as an aluminum laminate sheet, a stainless steel laminate sheet, a copper laminate sheet, or an iron laminate sheet. One specific example of the aluminum laminate sheet is a three-layer PE/Al/PET laminate sheet having a first insulating layer 41 of PE, a metal layer 43 of Al, and a second insulating layer 42 of PET. Another specific example of the aluminum laminate sheet is a three-layer PE/Al/NY laminate sheet having a first insulating layer 41 of PE, a metal layer 43 of Al, and a second insulating layer 42 of NY.

Each of the first insulating layer 41, the second insulating layer 42, and the metal layer 43 may have a single-layer structure or a multi-layer structure. Therefore, each of the first sheet member 31 and the second sheet member 32 may have a structure of three or more layers, and may be, for example, a laminated sheet having a four-layer structure made of CPP/NY/Al/PET or the like.

As described above, the outer encasement 30 is formed by a pair of sheet members joined to each other so as to wrap the laminate 10, and seals the laminate 10 inside. Each of the pair of sheet members includes a first insulating layer 41 and a second insulating layer 42, a metal layer 43, and a peeling portion in which a portion of each of the first insulating layer 41 and the second insulating layer 42 is peeled from the metal layer 43. The first insulating layer 41 and the second insulating layer 42 are a pair of insulating layers. The metal layer 43 is disposed between the first insulating layer 41 and the second insulating layer 42. Then, the first peeling portion 44, which is a peeling portion of the first sheet member 31, which is one of the pair of sheet members, is disposed so as to face the anode terminal electrode 12. The second peeling portion 45, which is a peeling portion of the second sheet member 32, which is the other of the pair of sheet members, is disposed so as to face the cathode terminal electrode 13.

The interior of the outer encasement 30 may be depressurized. Since the inside of the outer encasement 30 is depressurized, the surface pressure is applied to the laminate 10 accommodated in the interior of the outer encasement 30, and thus unevenness in the current density in the power storage module 1 is suppressed.

The outer encasement 30 may include a first adhesive layer 51 and a second adhesive layer 52. Each of the first adhesive layer 51 and the second adhesive layer 52 has conductivity. Each of the first adhesive layer 51 and the second adhesive layer 52 may be formed by applying a conductive adhesive such as a conductive epoxy adhesive or a conductive silicone adhesive to one face 43a of the first peeling portion 44 and one face 43a of the second peeling portion 45.

The first adhesive layer 51 is disposed between the first peeling portion 44 and the current collector 15 included in the anode terminal electrode 12. The first adhesive layer 51 adheres the first peeling portion 44 to the current collector 15 included in the anode terminal electrode 12. The second adhesive layer 52 is disposed between the second peeling portion 45 and the current collector 15 included in the cathode terminal electrode 13. The second adhesive layer 52 adheres the second peeling portion 45 to the current collector 15 included in the cathode terminal electrode 13.

By providing the first adhesive layer 51 and the second adhesive layer 52 on the outer encasement 30, it is possible to reliably ensure conduction between the first peeling portion 44 and the current collector 15 included in the anode terminal electrode 12, and conduction between the second peeling portion 45 and the current collector 15 included in the cathode terminal electrode 13. As a result, an increase in resistance in the power storage module 1 is suppressed. Further, by providing the first adhesive layer 51 and the second adhesive layer 52 on the outer encasement 30, misalignment of the laminate 10 in the interior of the outer encasement 30 that may occur when an external force is applied to the power storage module 1 is suppressed.

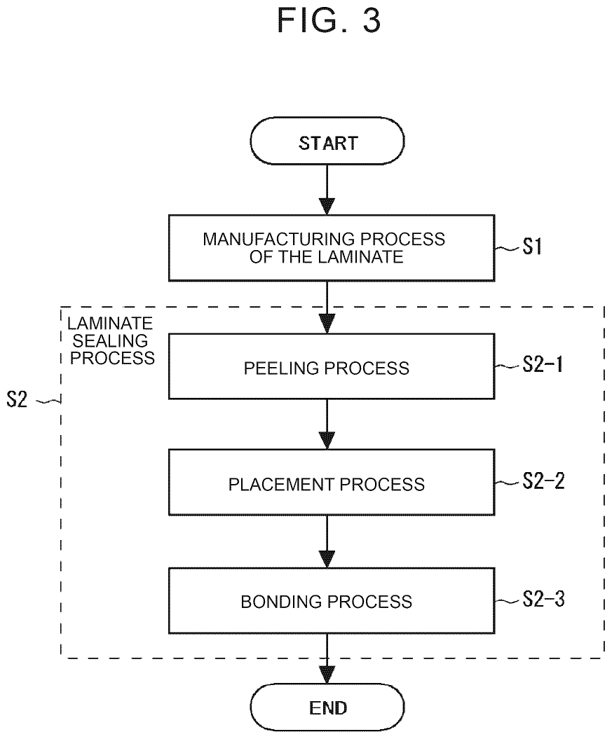

Next, a method of manufacturing the power storage module 1 according to the first embodiment will be described with reference to FIG. 3. FIG. 3 is a flowchart illustrating a method of manufacturing the power storage module according to the first embodiment. As shown in FIG. 3, the method for manufacturing the power storage module 1 includes a laminate manufacturing step (S1) for manufacturing the laminate 10 and a laminate sealing step (S2) for sealing the laminate 10 inside the outer encasement 30.

In the laminate manufacturing step, first, a plurality of bipolar electrodes 11, a cathode terminal electrode 13, and an anode terminal electrode 12 are prepared as a plurality of electrodes, and a plurality of separators 14 are prepared. Then, in the lamination body manufacturing step, a plurality of electrodes is laminated along the Z direction via the separator 14 to obtain the laminate 10. At this time, a plurality of electrodes is stacked such that one face 15a of the respective current collectors 15 is oriented in the same direction along the Z direction, and a plurality of bipolar electrodes 11 are disposed between the cathode terminal electrode 13 and the anode terminal electrode 12. Further, the sealing portion 20 may be formed in the peripheral portion of the laminate 10. The sealing portion 20 can be formed, for example, by injection molding a resin material that is a material of the sealing portion 20. For example, the electrolyte may be injected into each space S through an injection port provided in the sealing portion 20.

Next, the laminate sealing step includes, for example, a peeling step (S2-1), a disposing step (S2-2), and a bonding step (S2-3). In the peeling step, a peeling portion (the first peeling portion 44 and the second peeling portion 45) in which a portion of each of the first insulating layer 41 and the second insulating layer 42 is peeled from the metal layer 43 is formed. The first sheet member 31 and the second sheet member 32 can be obtained by the peeling step. For example, the first sheet member 31 and the second sheet member 32 before forming the first peeling portion 44 and the second peeling portion 45 are irradiated with laser light. The first insulating layer 41 and the second insulating layer 42 in the portion irradiated with the laser beam are separated from the metal layer 43. As a result, the first peeling portion 44 and the second peeling portion 45 can be formed.

The type of the laser may be appropriately selected according to the materials of the first insulating layer 41 and the second insulating layer 42. Types of lasers include YAG lasers, fiber lasers, semiconductor lasers, carbon dioxide lasers, helium neon lasers, excimer lasers, argon lasers, and the like. By using such laser processing, since the first insulating layer 41 and the second insulating layer 42 can be peeled off at a high speed, the first peeling portion 44 and the second peeling portion 45 can be formed in a short time. A method of forming the first peeling portion 44 and the second peeling portion 45 is not limited to a method using laser processing. The method of forming the first peeling portion 44 and the second peeling portion 45 may be, for example, a method of dissolving a portion of each of the first insulating layer 41 and the second insulating layer 42 with an appropriate solvent and peeling it from the metal layer 43. The method of forming the first peeling portion 44 and the second peeling portion 45 may be a method using a cutting process such as milling in which a portion of each of the first insulating layer 41 and the second insulating layer 42 is cut and peeled from the metal layer 43.

Next, in the disposing step, the first sheet member 31 and the second sheet member 32 are arranged such that the first peeling portion 44 faces the anode terminal electrode 12 included in the laminate 10 and the second peeling portion 45 faces the cathode terminal electrode 13 included in the laminate 10. Further, in the disposing step, the first sheet member 31 and the second sheet member 32 are overlapped with the laminate 10 interposed therebetween.

Next, in the joining step, the contacting surfaces of the peripheral edge portions 31a, 32a of the first sheet member 31 and the second sheet member 32 which are stacked in the above-described arrangement are joined together. By the joining process, a joining portion is formed. When the joint portion is formed, the inside of the outer encasement 30 is sealed. The method of joining the first sheet member 31 and the second sheet member 32 is not particularly limited, and examples thereof include a method of welding the first insulating layers 41 to each other and an adhesive bonding. As a method for spreading the first insulating layer 41 each other, the heat plate coating method, the ultrasonic coating method, the vibrating coating method, or laser coating method and the like. In addition, the laminate sealing step may include a depressurization step before the bonding step. In the decompression step, the inside of the outer encasement 30 is decompressed by using a vacuum pump or the like.

As described above, the method for manufacturing the power storage module 1 according to the present embodiment includes a laminate manufacturing step and a laminate sealing step. In the laminate manufacturing step, the laminate 10 including a plurality of electrodes stacked along the Z direction, which is the lamination direction, is manufactured. In the laminate sealing step, the laminate 10 is sealed in the outer encasement 30 formed by a pair of sheet members joined to each other so as to wrap the laminate 10. The plurality of electrodes each include a current collector 15 having one face 15a and the other face 15b facing each other in the Z direction and having one face 15a facing the same direction along the Z direction. The plurality of electrodes includes a cathode terminal electrode 13, an anode terminal electrode 12, and at least one bipolar electrode 11 disposed between the cathode terminal electrode 13 and the anode terminal electrode 12. The cathode terminal electrode 13 includes a cathode active material layer 16 provided on one face 15a of the current collector 15. The anode terminal electrode 12 includes an anode active material layer 17 provided on the other face 15b of the current collector 15 so as to face the cathode active material layer 16. Each of the pair of sheet members includes a first insulating layer 41 and a second insulating layer 42, a metal layer 43, and a peeling portion in which a portion of each of the first insulating layer 41 and the second insulating layer 42 is peeled from the metal layer 43. The first insulating layer 41 and the second insulating layer 42 are a pair of insulating layers. The metal layer 43 is disposed between the first insulating layer 41 and the second insulating layer 42. The first peeling portion 44, which is a peeling portion of the first sheet member 31, which is one of the pair of sheet members, is disposed so as to face the anode terminal electrode 12. The second peeling portion 45, which is a peeling portion of the second sheet member 32, which is the other of the pair of sheet members, is disposed so as to face the cathode terminal electrode 13.

According to such a manufacturing method, the power storage module 1 illustrated in FIGS. 1 and 2 can be manufactured.

The present disclosure is not limited to the above-described embodiments, and can be appropriately modified without departing from the scope of the present disclosure. For example, in the above embodiment, the outer encasement 30 formed by the first sheet member 31 and the second sheet member 32 is taken as an example. In the first sheet member 31 and the second sheet member 32, the joining surfaces of the peripheral edge portions 31a, 32a are joined to each other while the peripheral edge portions 31a, 32a of the first sheet member 31 and the second sheet member 32 are arranged so as to substantially coincide with each other. The configuration of the outer encasement 30 is not limited to this.

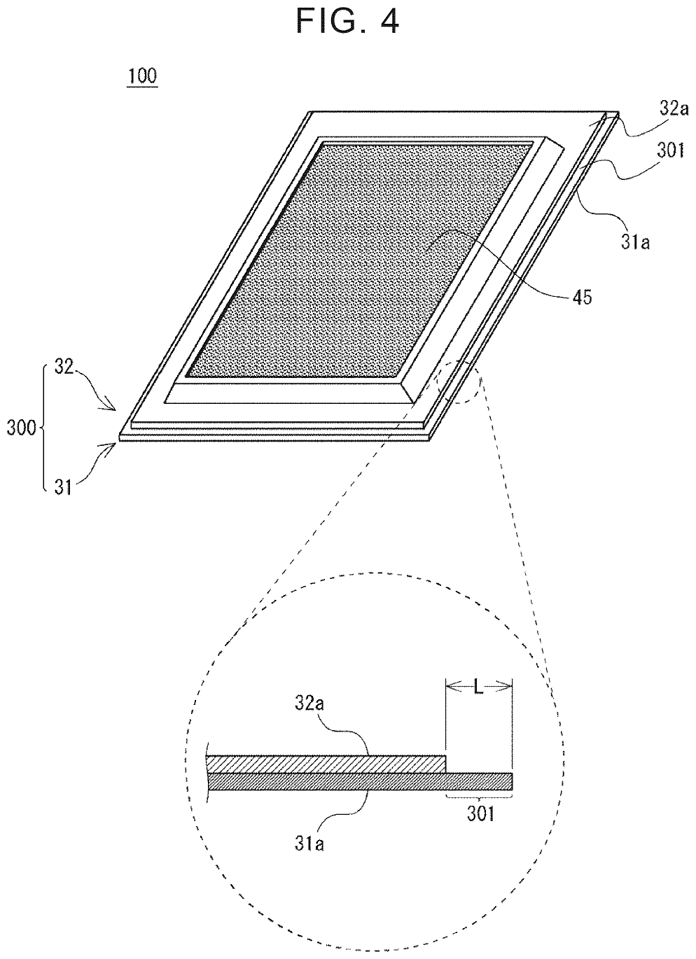

Therefore, FIG. 4 is a perspective view and a partially enlarged cross-sectional view of the power storage module according to the modification. The perspective view of FIG. 4 corresponds to FIG. 2. The power storage module 100 illustrated in FIG. 4 has the same configuration as that of the power storage module 1 except that the power storage module includes the outer encasement 300 instead of the outer encasement 30.

The outer encasement 300 of the power storage module 100 is formed by the first sheet member 31 and the second sheet member 32. In the first sheet member 31 and the second sheet member 32, the contacting surfaces of the peripheral edge portions 31a, 32a are joined to each other while the peripheral edge portions 31a, 32a of the first sheet member 31 and the second sheet member 32 are arranged so as to be displaced from each other. The power storage module 100 including the outer encasement 300 is suitable for a case where the first sheet member 31 and the second sheet member 32 in which the metal layer 43 is exposed at each end face are used.

An enlarged cross-sectional view of the joint portion of the outer encasement 300 is shown in the broken line in FIG. 4. The outer encasement 300 is obtained by joining the contacting surfaces of the peripheral edge portions 31a, 32a of the first sheet member 31 and the second sheet member 32, which are overlapped with the peripheral edge portion 31a being disposed 1 mm or more outward of the peripheral edge portion 32a. The outer encasement 300 thus obtained has a protruding portion 301 in which the first sheet member 31 protrudes outward from the second sheet member 32. That is, the protrusion amount L of the protruding portion is 1 mm or more. Note that the protrusion amount L is a distance between the end face of the first sheet member 31 and the end face of the second sheet member 32.

In the power storage module 100 in which the laminate 10 is sealed in the outer encasement 300 configured as described above, the creepage distance between the metal layer 43 of the first sheet member 31 and the metal layer 43 of the second sheet member 32 is secured. Therefore, short-circuiting between the first sheet member 31 and the second sheet member 32, which may occur when the metal layer 43 is exposed on the end surfaces of the first sheet member 31 and the second sheet member 32, is suppressed.

What is claimed is:

1. A power storage module comprising:
a laminate including a plurality of electrodes laminated along a laminating direction; and
an outer encasement that is made up of a pair of sheet members joined to each other so as to envelop the laminate, and that seals the laminate inside, wherein:
the electrodes each contain a current collector having one face and another face opposed to each other in the laminating direction, with the one face oriented in a same direction along the laminating direction, the electrodes including
a cathode terminal electrode including a cathode active material layer provided on the one face of the current collector,
an anode terminal electrode including an anode active material layer provided on the other face of the current collector so as to oppose the cathode active material layer, and
at least one bipolar electrode disposed between the cathode terminal electrode and the anode terminal electrode; and
each of the sheet members includes
a pair of insulating layers,
a metal layer disposed between the insulating layers, and
a peeling portion in which a portion of each of the insulating layers is peeled away from the metal layer, in which the peeling portion of one of the sheet members is disposed opposing the anode terminal electrode, and the peeling portion of the other of the sheet members is disposed opposing the cathode terminal electrode.

2. The power storage module according to claim 1, wherein:
the outer encasement is fashioned with a protruding portion in which one of the sheet members protrudes outward beyond the other of the sheet members; and
an amount of protrusion of the protruding portion is 1 mm or more.

3. The power storage module according to claim 1, wherein inside of the outer encasement is depressurized.

4. The power storage module according to claim 1, wherein:
the outer encasement includes a pair of adhesive layers with conductivity;
one of the adhesive layers adheres the peeling portion opposing the cathode terminal electrode to the current collector included in the cathode terminal electrode; and
another of the adhesive layers adheres the peeling portion opposing the anode terminal electrode to the current collector included in the anode terminal electrode.

5. A manufacturing method of a power storage module, the manufacturing method comprising:
fabricating a laminate including a plurality of electrodes laminated along a laminating direction; and
sealing the laminate inside an outer encasement that is made up of a pair of sheet members joined to each other so as to envelop the laminate, wherein:
the electrodes each contain a current collector having one face and another face opposed to each other in the laminating direction, with the one face oriented in a same direction along the laminating direction, the electrodes including
a cathode terminal electrode including a cathode active material layer provided on the one face of the current collector,
an anode terminal electrode including an anode active material layer provided on the other face of the current collector so as to oppose the cathode active material layer, and
at least one bipolar electrode disposed between the cathode terminal electrode and the anode terminal electrode; and
each of the sheet members includes
a pair of insulating layers,
a metal layer disposed between the insulating layers, and
a peeling portion in which a portion of each of the insulating layers is peeled away from the metal layer, in which the peeling portion of one of the sheet members is disposed opposing the anode terminal electrode, and the peeling portion of the other of the sheet members is disposed opposing the cathode terminal electrode.
